(19) United States
(12) Patent Application Publication
(10) Pub. No.: US 2009/0122338 A1
(43) Pub. Date: May 14, 2009

(54) IMAGE FORMING SYSTEM AND IMAGE FORMING APPARATUS

(76) Inventor: Fumiyuki YOSHIDA, Kanagawa (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/268,626

(22) Filed: Nov. 11, 2008

(30) Foreign Application Priority Data
Nov. 14, 2007 (JP) 2007-296062

(51) Int. Cl. G06F 3/12

(52) U.S. Cl. 358/1.15

(57) ABSTRACT

A disclosed image forming apparatus is used in an image forming system in which a print request apparatus to be used by a user and plural image forming apparatuses are connected via a network. The image forming apparatus includes a print unit configured to print a print data piece, a communications unit configured to communicate with the print request apparatus and the other image forming apparatuses, a storage unit configured to store printing performance information pieces of the image forming apparatus and the other image forming apparatuses, and a selection reporting unit configured to select, when a print request is received from the print request apparatus, one of the image forming apparatuses which has a most suitable printing performance capability for the print request based on the printing performance information stored in the storage unit and report the selected image forming apparatus to the print request apparatus.

### BACKGROUND OF THE INVENTION

1. Field of the Invention

The present invention generally relates to an image forming system using plural image forming apparatuses connected to a network; and an image forming apparatus for use in this system, and particularly relates to allocation of print jobs.

2. Description of the Related Art

Image forming systems are known that include plural image forming apparatuses, such as printers, connected via a network. In the case of related-art image forming systems, the variety of image forming apparatuses included in the systems and the number of the image forming apparatuses used by each user are small, so that the users do not have to think about which image forming apparatus is suitable for printing a document. Techniques related to these related-art image forming systems are disclosed in, for example, Japanese Patent Laid-Open Publication No. 2004-295249 (Patent Document 1), Japanese Patent Laid-Open Publication No. 2004-178362 (Patent Document 2), and Japanese Patent Laid-Open Publication No. 2002-262014 (Patent Document 3).

In these years, however, a wide variety of image forming apparatuses have become available, such as models that are slow in the printing speed but are capable of printing color images at high quality and models that support only monochrome printing but are capable of printing at high speed. Further, it has become common to connect dozens of image forming apparatuses via a network so that a user performs printing using one of the image forming apparatuses. Thus, it has become difficult for users to determine which apparatus can satisfy their printing requests at the highest level.

Patent Document 1 discloses an image processing apparatus. According to Patent Document 1, in a system in which the image processing apparatus, a peripheral device with image processing ability, and a client terminal are connectable to each other via a network, the image processing apparatus detects image processing abilities of the image processing apparatus and the peripheral device in response to a request for transmission of an image from the client terminal while determining the attributes of the image. The image processing apparatus performs determination of attributes for every image to be printed and therefore can provide detailed control. However, since image analysis and image processing ability detection are performed for each print job, in the case where a large number of print jobs are requested, the printing performance is reduced due to heavy network traffic and excessive workload on the CPU of the image forming apparatus.

Patent Document 2 discloses a document management system including an information processing apparatus that stores document management software for centrally managing plural pieces of document data, an image forming apparatus as an output device, and a network connected to the information processing apparatus and the image forming apparatus. In this system, detailed control can be provided by the software running on the information processing apparatus at the user's end, and therefore it is possible to prevent an increase in workload to be placed on the image forming apparatus and the network during printing. However, since the document management software needs to be installed at the user's end, the types of platforms that can be used at the user's end are limited. For example, if the software runs only on predetermined operating systems such as Windows (registered trademark), this system does not work with non-Windows platforms. Further, the techniques of Patent Documents 1 and 2 share a common problem in that print jobs are concentrated on a certain image forming apparatus. Patent Document 3 discloses a technique of enhancing the productivity by operating plural image forming apparatuses in a coordinated manner. This technique, however, does not provide a satisfactory solution to the above-described problem.

### SUMMARY OF THE INVENTION

In view of the foregoing, the present invention is directed toward providing an image forming system capable of easily selecting, upon reception of a print request from a user, an image forming apparatus that can satisfy the print request at the highest level from plural image forming apparatuses connected to a network.

In an embodiment of the present invention, there is disclosed an image forming apparatus for use in an image forming system in which a print request apparatus to be used by a user and plural image forming apparatuses are connected via a network. The image forming apparatus includes a print unit configured to print a print data piece; a communications unit configured to communicate with the print request apparatus and the other image forming apparatuses; a storage unit configured to store printing performance information pieces of the image forming apparatus and the other image forming apparatuses; and a selection reporting unit configured to select, when a print request is received from the print request apparatus, one of the image forming apparatuses which has a most suitable printing performance capability for the print request based on the printing performance information stored in the storage unit and report the selected image forming apparatus to the print request apparatus.

According to another embodiment of the present invention, there is disclosed an image forming system that includes a print request apparatus configured to be used by a user; and plural image forming apparatuses connected to the print request apparatus via a network; wherein each of the image forming apparatuses stores printing performance information pieces of the image forming apparatuses connected to the network; the print request apparatus sends a print request to one of the image forming apparatuses; and the one of the image forming apparatuses selects one of the image forming apparatuses having a printing performance capability suitable for the print request and reports the selected image forming apparatus to the print request apparatus.

According to an aspect of the present invention, it is possible to select an image forming apparatus that can most suitably satisfy a print request from a user. Further, the user can select the image forming apparatus without considering which image forming apparatus can provide the highest performance to print his/her document. The user can also obtain a service that best satisfies his/her print request.

### BRIEF DESCRIPTION OF THE DRAWINGS

FIG. 1 is a sequence diagram illustrating operations performed when an image forming apparatus is connected to a network;

FIG. 2 is a sequence diagram illustrating operations according to a first embodiment of the present invention;

FIG. 3 is a sequence diagram illustrating operations according to a second embodiment of the present invention;

FIG. 4 is a sequence diagram illustrating operations according to a third embodiment of the present invention;

FIG. 5 is a diagram illustrating a printing performance list;

FIG. 6 is a diagram illustrating an example of an interface of a PC used by a user to specify print parameters to an image forming system;

FIG. 7 is a flowchart illustrating an apparatus selection procedure;

FIG. 8 is a flowchart illustrating an apparatus selection procedure for an image quality priority mode;

FIG. 9 is a diagram illustrating an apparatus selection operation;

FIG. 10 is a diagram illustrating a rejecting apparatus exclusion operation;

FIG. 11 is a diagram illustrating a rejecting apparatus exclusion cancellation operation;

FIG. 12 is a flowchart illustrating a workload calculation procedure;

FIG. 13 is a diagram illustrating an example of information displayed on an operations panel during printing;

FIGS. 14A-14H are diagrams each illustrating content of communications exchanged among a PC and image forming apparatuses;

FIG. 15 is a schematic diagram illustrating an exemplary configuration of an image forming system according to an embodiment of the present invention; and

FIG. 16 is a block diagram illustrating an exemplary functional configuration of an image forming apparatus according to an embodiment of the present invention.

### DETAILED DESCRIPTION OF THE PREFERRED EMBODIMENT

First through third embodiments of the present invention are described below with reference to the accompanying drawings.

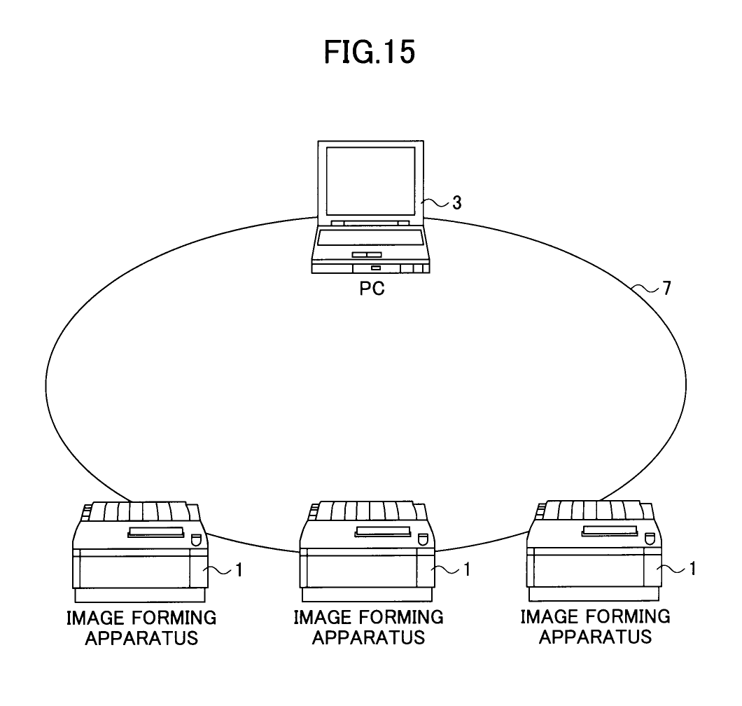

Referring to FIG. 15, an image forming system of each embodiment includes a personal computer (PC) 3 that is used by a user to make a print request and plural image forming apparatuses 1 that have different printing performance capabilities and print a print data piece sent from the PC 3 in response to the print request. The PC 3 and the image forming apparatuses 1 are connected via a network 7.

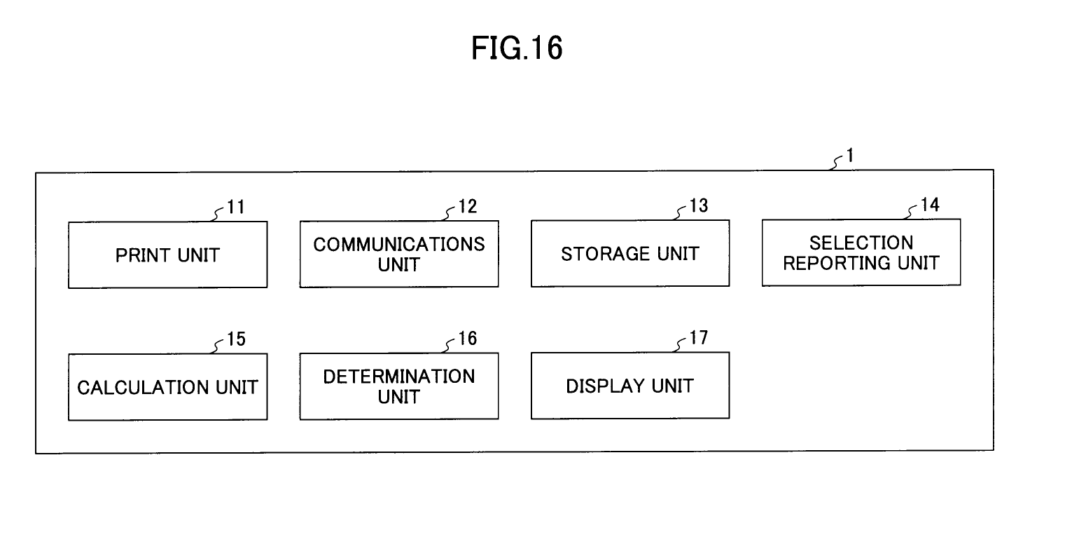

Referring to FIG. 16, the image forming apparatus 1 includes a print unit 11 configured to print a print data piece, a communications unit 12 configured to communicate with the PC 3 and the other image forming apparatuses 1, a storage unit 13 configured to store printing performance information pieces of the image forming apparatus 1 and the other image forming apparatuses 1, and a selection reporting unit 14 configured to select, when a print request is received from the PC 3, one of the image forming apparatuses 1 which has a most suitable printing performance capability for the print request based on the printing performance information stored in the storage unit 13 and report the selected image forming apparatus 1 to the PC 3. The image forming apparatus 1 may further include a calculation unit 15 configured to calculate, when the print request is received from the PC 3, a workload to perform printing based on a printing performance information piece contained in the print request. The image forming apparatus 1 may further include a determination unit 16 configured to determine whether the image forming apparatus 1 can satisfy the print request based on the calculated workload. The image forming apparatus 1 may further include a display unit 17 (operations panel) configured to display an identification information piece that uniquely identifies one of the image forming apparatuses 1 and that is received from the one of the other image forming apparatuses 1 together with the information indicating that printing can be performed.

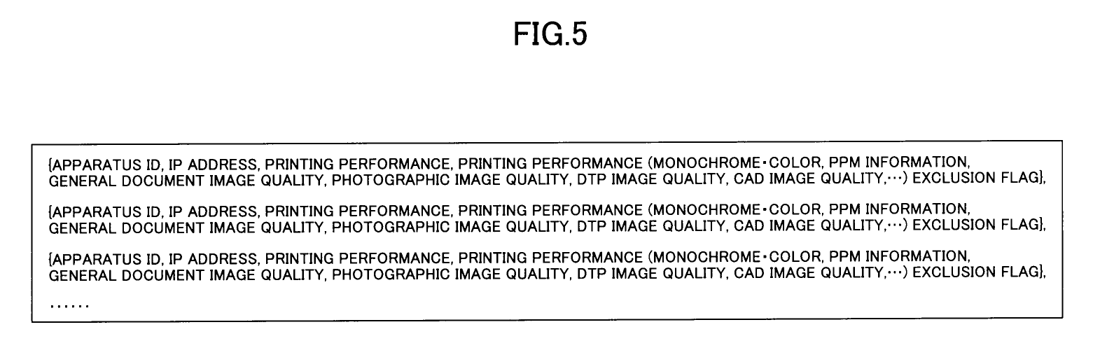

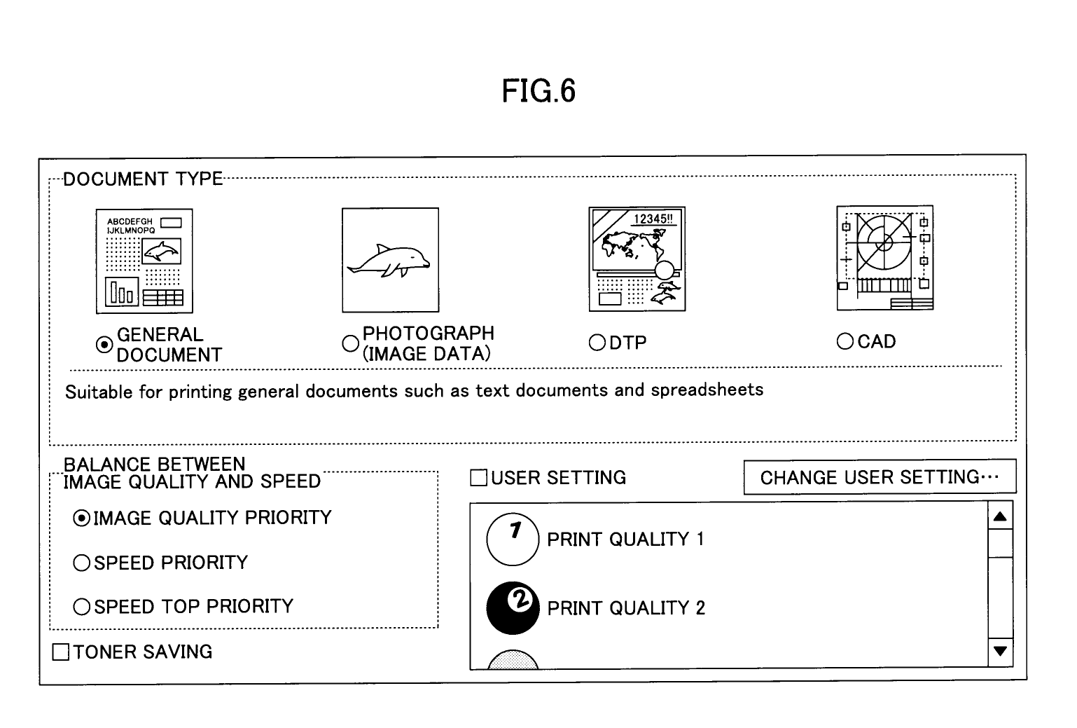

FIG. 6 is a diagram illustrating an example of an interface of the PC 3 used by a user to specify print parameters to the image forming system 100 of each embodiment. The interface shown in FIG. 6 includes options for items such as document type, balance between image quality and speed, and print quality. A user chooses one option for each item to make a print request. An image forming apparatus 1 having printing performance capabilities corresponding to the chosen options is selected and prints a print data piece sent from the PC 3.

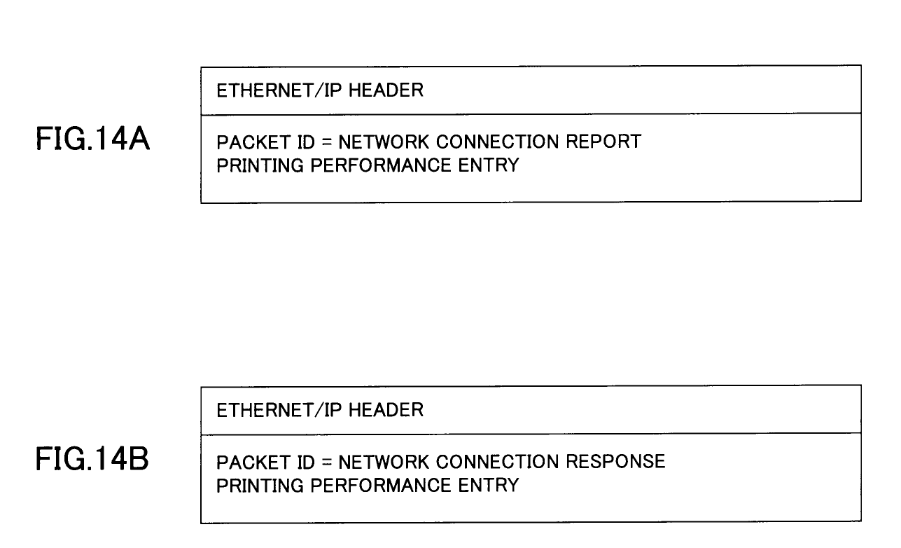

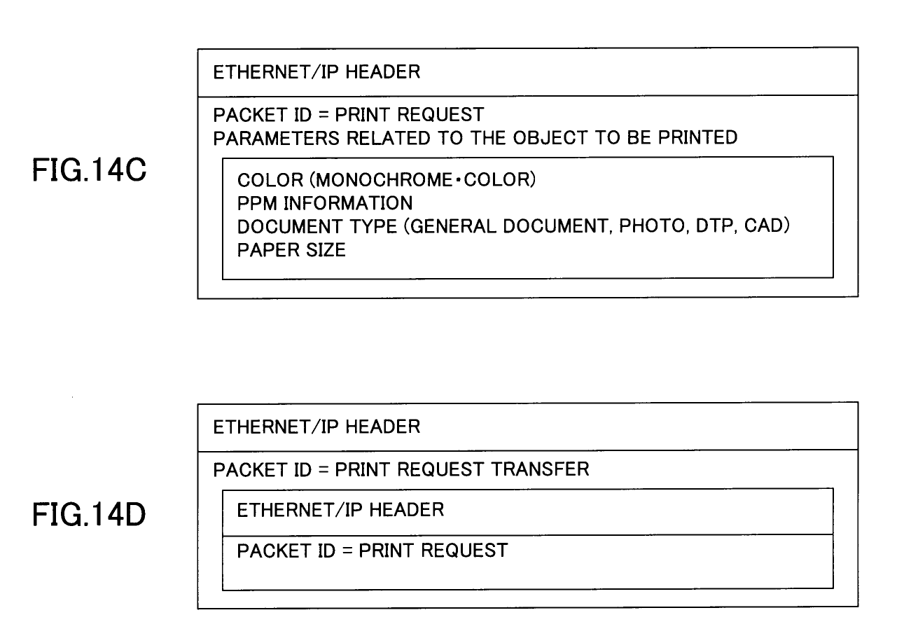

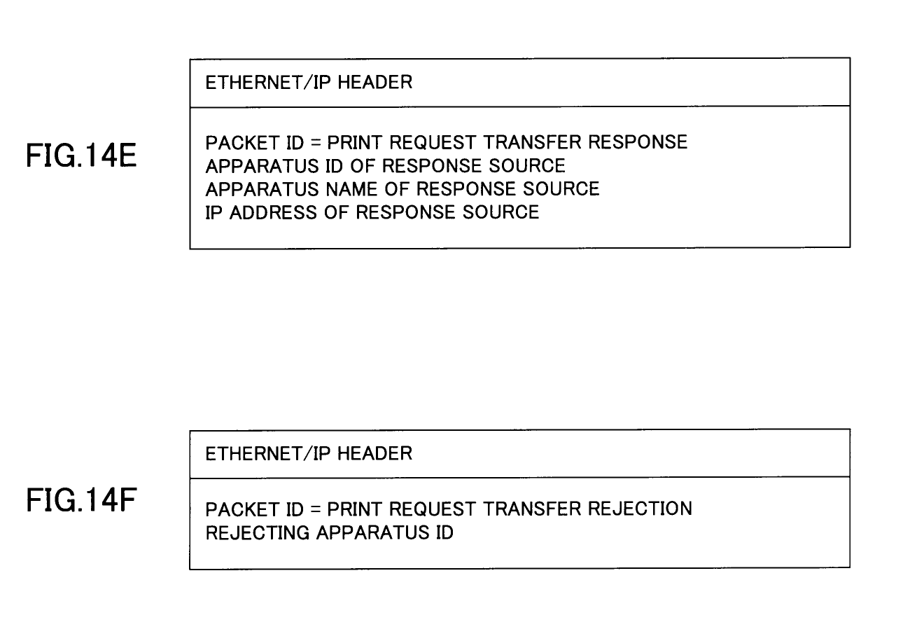

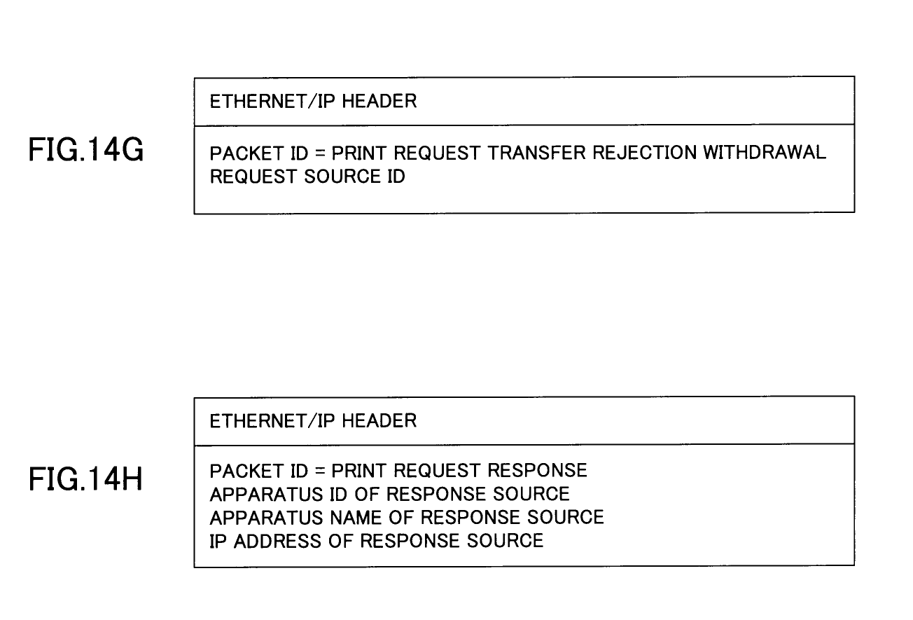

FIGS. 14A thorough 14H are diagrams illustrating content of communications 1 through 8 (described below), respectively, exchanged between the PC 3 and the image forming apparatuses 1 according to the first through third embodiments.

First, the first embodiment is described below with reference to the accompanying drawings.

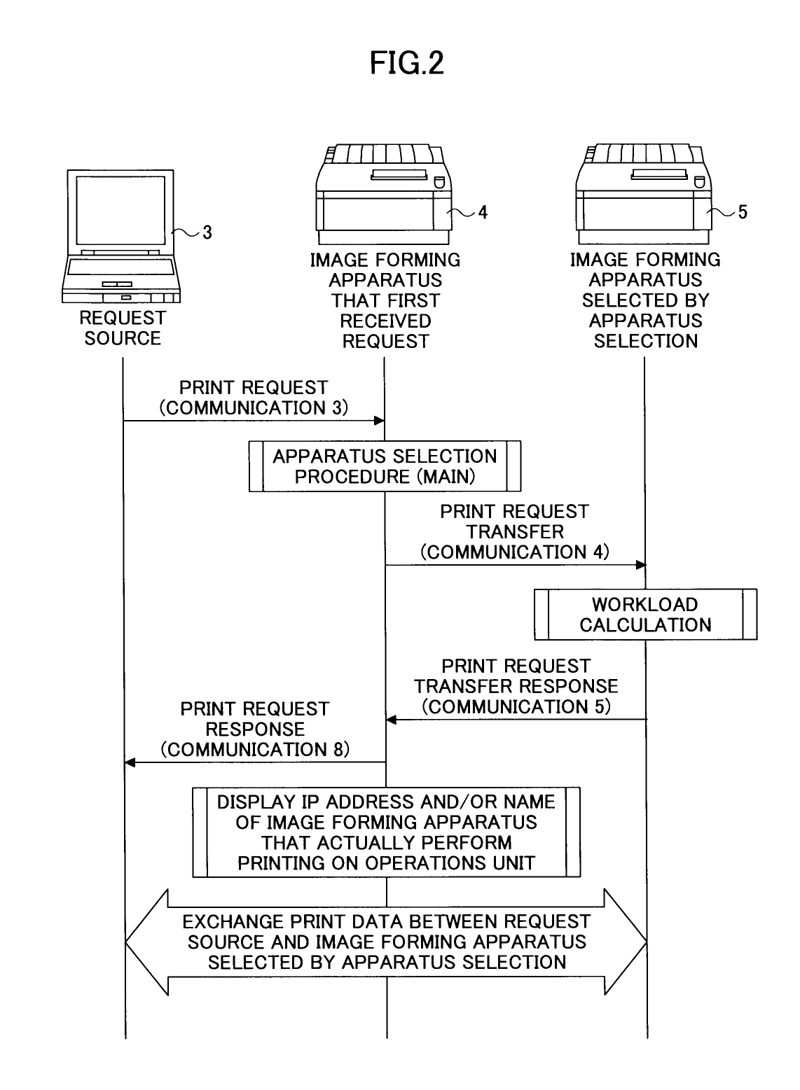

This embodiment illustrates a print method that is used in the case where an image forming apparatus having higher printing performance capabilities than an image forming apparatus that has first received a print request is present on a network 7 (see FIG. 2).

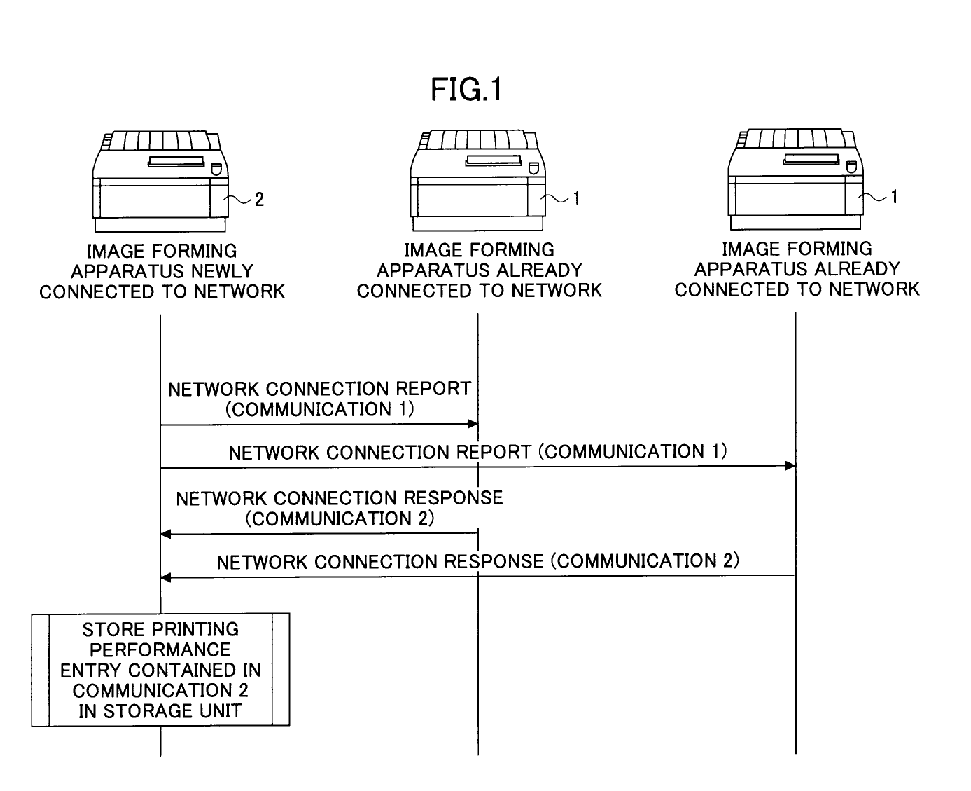

(1) Referring to FIG. 1, in the case where plural image forming apparatuses 1 are already connected to a network 7, when another image forming apparatus 1 (hereinafter referred to as an “image forming apparatus 2”) is powered on and is newly connected to the network 7, the image forming apparatus 2 sends, to the other image forming apparatuses 1 that are already connected to the network 7, a network connection report (i.e., a “communication 1”) shown in FIG. 14A indicating that the image forming apparatus 2 is connected to the network 7. The communication 1 is sent using broadcast communications.

(2) Each of the image forming apparatuses 1 sends a network connection response (i.e., a “communication 2”) shown in FIG. 14B, to the source of the network connection report of the communication 1 (i.e., the image forming apparatus 2). The sent packet of the communication 2 contains a printing performance entry, which is a group of parameters related to the printing performance capability of the image forming apparatus 1. The image forming apparatus 2 stores the received printing performance entry. That is, all the image forming apparatuses 1 and 2 store a list of the printing performance entries of all the image forming apparatuses 1 and 2.

(3) Referring now to FIG. 2, a user selects one of the image forming apparatus 1 and 2 (hereinafter referred to also as an “image forming apparatus 4” or a “user request destination apparatus”) and sends a print request (i.e., a “communication 3”) shown in FIG. 14C using the interface of a PC 3 of FIG. 6 in order to perform printing. The communication 3 contains “parameters related to the object to be printed” which are necessary for determining the required printing performance.

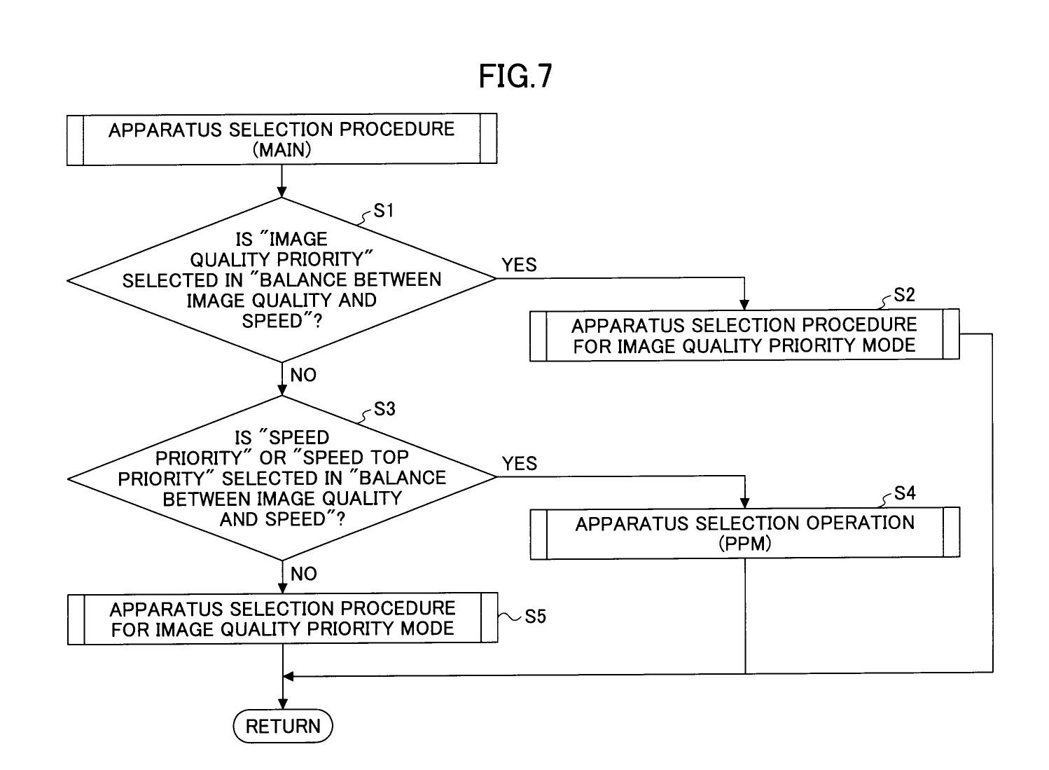

(4) The user request destination apparatus (image forming apparatus 4) selects the most suitable apparatus (image forming apparatus 1) for performing printing according to the procedures of FIGS. 7 thorough 9.

FIG. 7 is a flowchart illustrating an apparatus selection procedure.

The user request destination apparatus determines whether an image quality priority mode is specified in the print request (Step S1).

If an image quality priority mode is specified, an apparatus selection procedure for an image quality priority mode (described below) is performed (Step S2). On the other hand, if an image quality priority mode is not specified, the user request destination apparatus determines whether a speed priority mode or a speed top priority mode is specified (Step S2). If a speed priority mode or a speed top priority mode is specified, an apparatus selection operation (described below) is performed (Step S4). On the other hand, if neither a speed priority mode nor a speed top priority mode is specified, the apparatus selection procedure for an image quality priority mode is performed (Step S5)

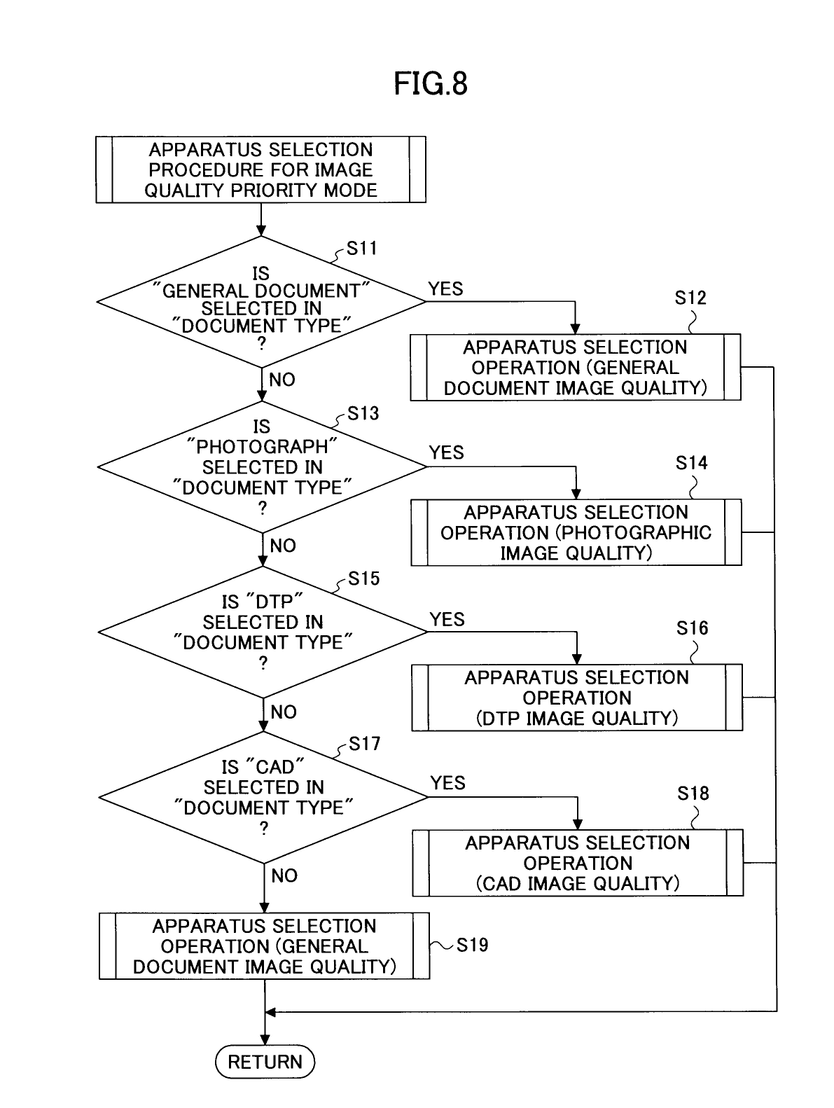

FIG. 8 is a flowchart illustrating the apparatus selection procedure for an image quality priority mode.

The user request destination apparatus determines whether a general document is specified as the document type (Step S11). If a general document is specified, an apparatus suitable for general document image quality printing is selected (Step S12). On the other hand, if a general document is not specified, the user request destination apparatus determines whether a photograph is specified as the document type (Step S13). If a photograph is specified, an apparatus selection operation is performed to select an apparatus suitable for photographic image quality printing (Step S14). On the other hand, if a photograph is not specified, the user request destination apparatus determines whether DTP is specified as the document type (Step S15). If DTP is specified, an apparatus selection operation is performed to select an apparatus suitable for DTP image quality printing (Step S16). On the other hand, if DTP is not specified, the user request destination apparatus determines whether CAD is specified as the document type (Step S17). If CAD is specified, an apparatus selection operation is performed to select an apparatus suitable for CAD image quality printing (Step S18). On the other hand, if CAD is not specified, an apparatus selection operation is performed to select an apparatus suitable for general document image quality printing (Step S19).

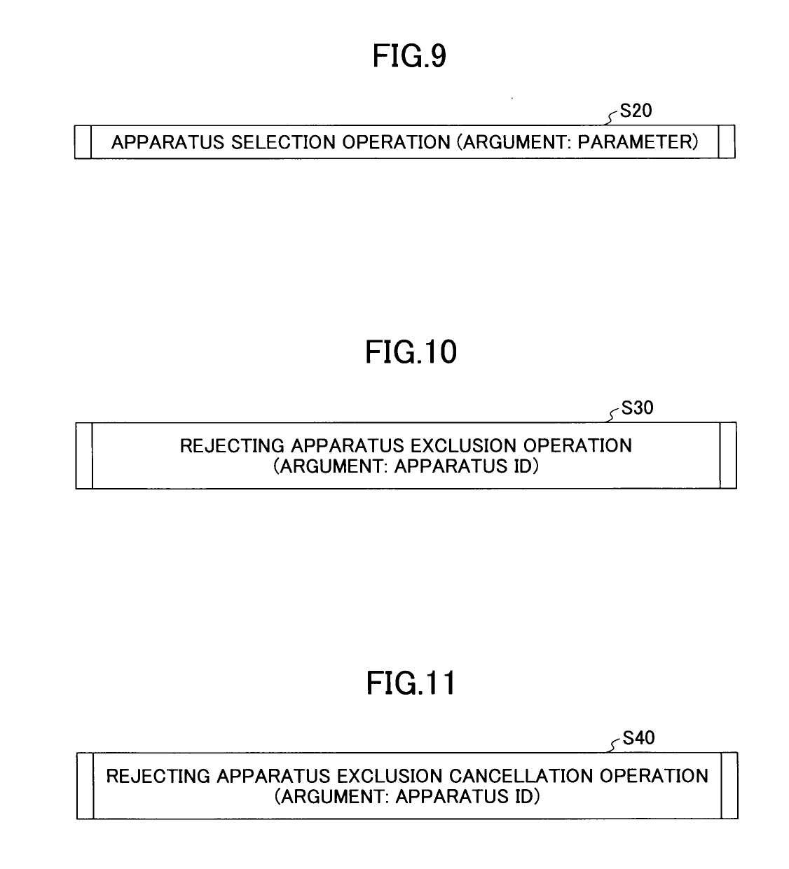

FIG. 9 is a diagram illustrating an apparatus selection operation (Step S20). In Step S20, the entry of an image forming apparatus that has the maximum value for a printing performance parameter of a printing performance list of FIG. 5 (described below) specified by an argument is returned. An apparatus with an exclusion flag being ON is excluded from candidates for selection.

Thus, it is determined that an apparatus (i.e., an image forming apparatus 5 of FIG. 2, hereinafter referred to as a “selected apparatus 1”) that is more suitable than the user request destination apparatus for performing a print job requested by a user is present on the network 7.

(5) The user request destination apparatus sends a print request transfer (i.e., a “communication 4”) shown in FIG. 14D to the selected apparatus 1 selected in (4). The print request transfer (the communication 4) includes a packet of the print request (the communication 3) as a member.

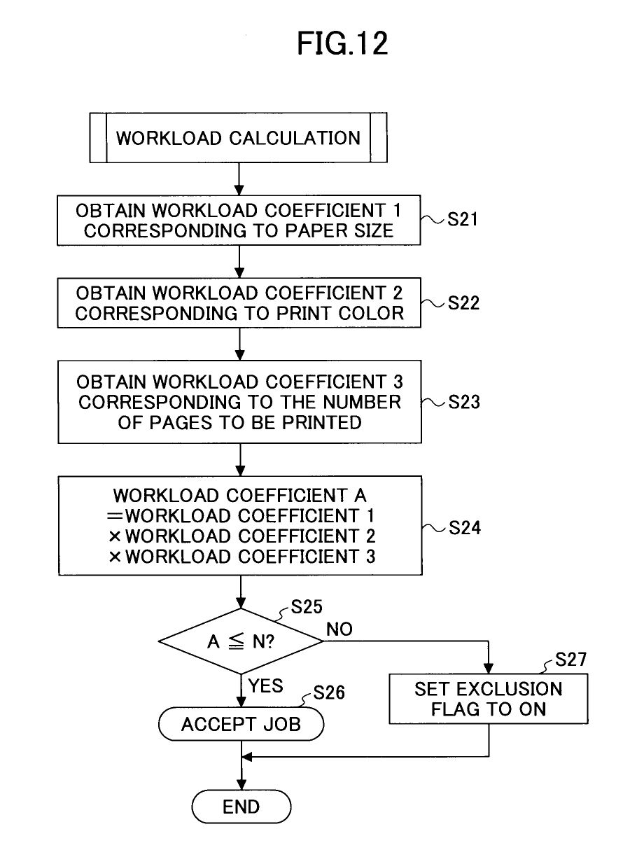

(6) Having received the communication 4, the selected apparatus 1 calculates workload of a print job(s) to be performed by the selected apparatus 1 according to a workload calculation procedure of FIG. 12. The workload calculated here may include the workload of the requested job.

Referring to FIG. 12, a workload coefficient 1 corresponding to the paper size, a workload coefficient 2 corresponding to the print color, and a workload coefficient 3 corresponding to the number of pages to be printed are obtained in Steps S21, S22, and S23, respectively. The workload coefficient 1 has a value statically determined based on the paper size. The greater the paper size, the higher the workload and the greater the workload coefficient 1. The workload coefficient 2 has a value statically determined based on whether the print color is monochrome or color. Color printing places higher workload and has a workload coefficient 2 greater than that of the monochrome printing. The greater the number of pages to be printed, the higher the workload and the greater the workload coefficient 3. In Step S24 a workload coefficient A is calculated, which is a product of the coefficients 1 through 3. In Step S25 it is determined whether the workload coefficient A is equal to or less than a predetermined value N. If the workload coefficient A is equal to or less than a predetermined value N, the selected apparatus 1 accepts the job. On the other hand, if the workload coefficient A is greater than a predetermined value N, an exclusion flag is set to ON. Thus the procedure ends.

(7) Then, if it is determined that the workload is not higher than a predetermined threshold and the selected apparatus 1 can accept the requested job, the selected apparatus 1 returns a print request transfer response (i.e., a “communication 5”) shown in FIG. 14E to the user request destination apparatus.

(8) The user request destination apparatus sends a print request response (i.e., a “communication 8”) shown in FIG. 14H to the PC 3 in order to report to the user an apparatus (the selected apparatus 1 in this example) which is to actually perform printing.

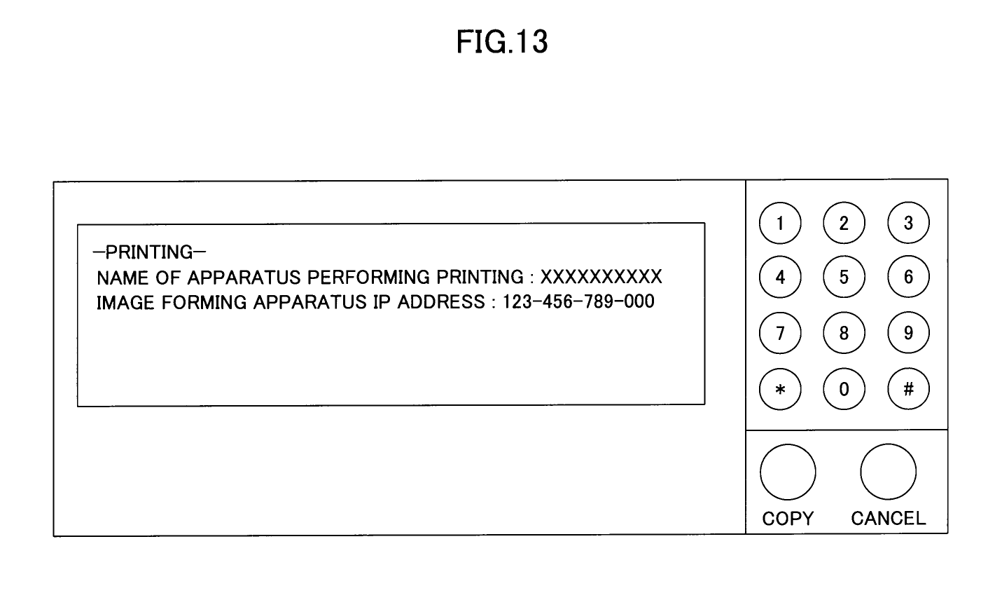

(9) Then, the user request destination apparatus displays information (e.g., apparatus name and IP address) that uniquely identifies the selected apparatus 1 on an operations panel of the user request destination apparatus as shown in FIG. 13. This information is contained in a packet of the communication 5 of (7) above.

(10) The PC 3 of the user sends a data piece to be printed to the selected apparatus 1.

Thus the selected apparatus 1 performs printing. Prior to performing printing (i.e., after receiving the print request response (i.e., the communication 8)), in order to send the print data piece to the selected apparatus 1, a printer device driver installed in the PC 3 of the user that has received the communication 8 changes the communication destination from the user request destination apparatus to the selected apparatus 1 based on the information contained in the communication 8.

According to this embodiment, it is possible to automatically select an image forming apparatus that can most suitably satisfy a print request from a user. Further, it is possible to forward the print request to the selected image forming apparatus, send a print data piece to the selected image forming apparatus, and perform printing without making the user aware of the print request being forwarded.

Next, the second embodiment of the present invention is described below.

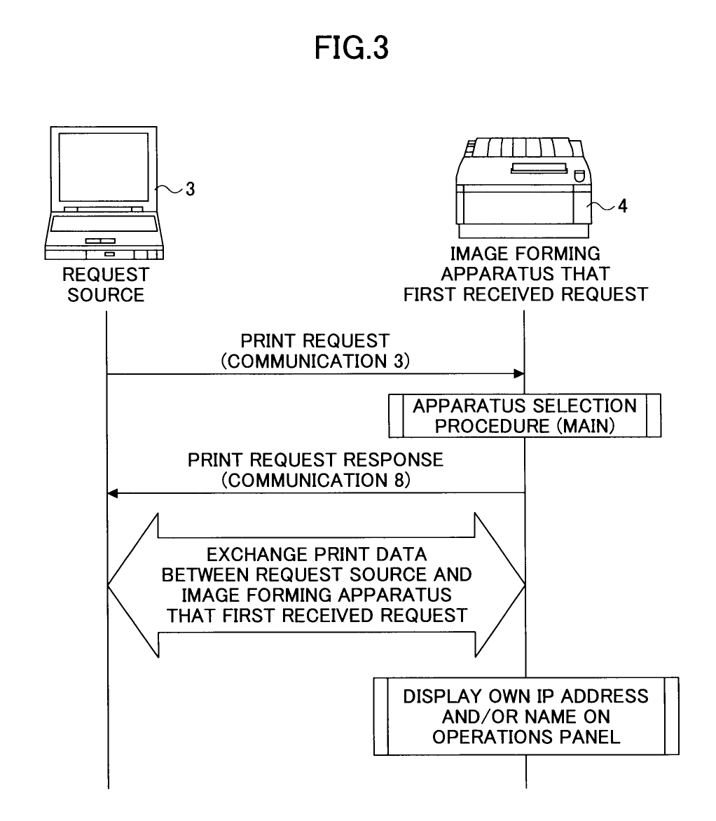

This embodiment illustrates the case where the image forming apparatus (image forming apparatus 4) that has first received a print request is the most suitable apparatus (see FIG. 3).

The above described (1) through (4) of the first embodiment are performed in the same manner so that the procedures of FIGS. 7 through 9 are performed. Thus, the user request destination apparatus is determined to be the most suitable apparatus.

(5) The user request destination apparatus sends a print request response (i.e., a “communication 8”) to the PC 3 of the user.

(6) The PC 3 of the user sends data to be actually printed to the user request destination apparatus. Thus the user request destination apparatus performs printing.

According to this embodiment, in the case where the image forming apparatus that has first received a print request is the most suitable apparatus, the PC 3 sends print data to the image forming apparatus. Thus it is possible to perform printing.

Next, the third embodiment of the present invention is described below.

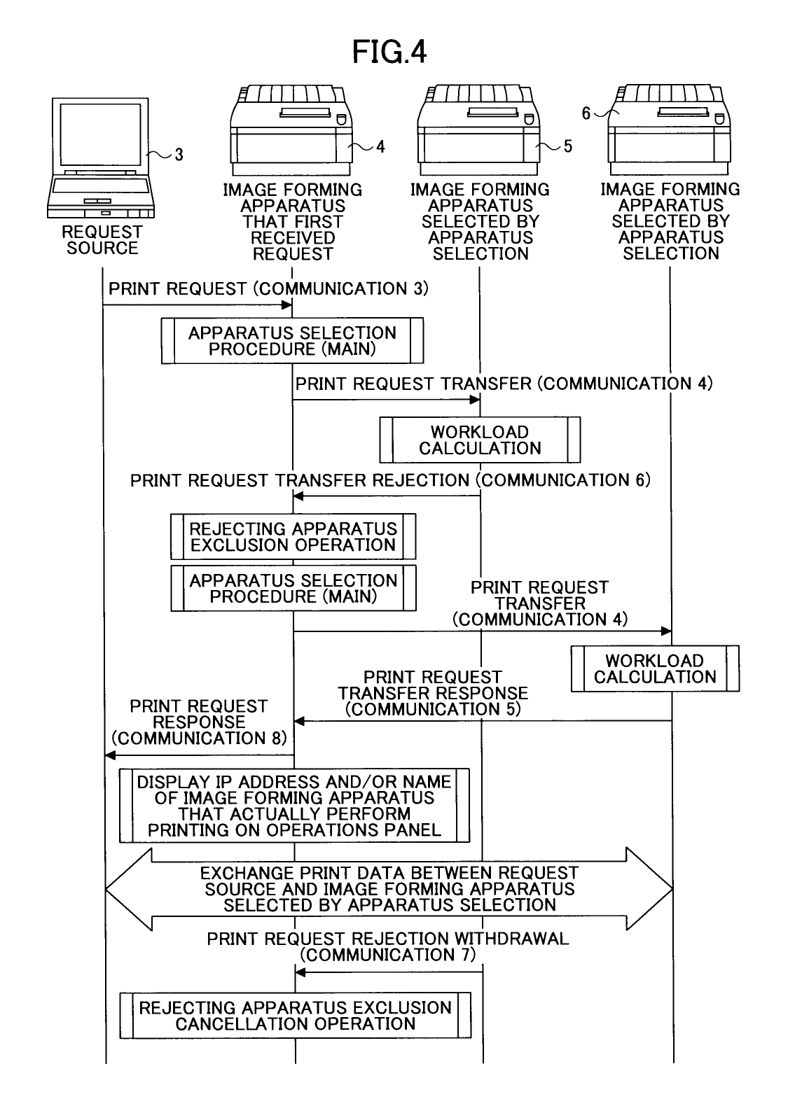

This embodiment describes the case where although the image forming apparatus 5 (i.e., the selected apparatus 1) having higher printing performance capability than the image forming apparatus 4 that has first received a print request is present on the network 7, the print request is rejected by the selected apparatus 1 because if otherwise a heavy workload would be placed on the selected apparatus 1 (see FIG. 4).

The above described (1) through (4) of the first embodiment are performed in the same manner so that the procedures of FIGS. 7-9 are performed. Thus, it is determined that the selected apparatus 1 (i.e., the image forming apparatus 5) that is more suitable than the user request destination apparatus for performing a print job requested by a user is present on the network 7.

(5) The user request destination apparatus sends a print request transfer (i.e., a “communication 4”) to the selected apparatus 1.

(6) Having received the communication 4, the selected apparatus 1 calculates workload of a print job(s) to be performed by the selected apparatus 1 according to the flow shown in FIG. 12. The workload calculated here may include the workload of the requested job.

(7) Then, it is determined that the workload is higher than a predetermined threshold and the selected apparatus 1 cannot accept the requested job (NO in Step S25). Accordingly, the selected apparatus 1 returns a print request transfer rejection (i.e., a “communication 6”) shown in FIG. 14F to the user request destination apparatus.

(8) Since the print request transfer is rejected in (7), the user request destination apparatus performs a rejecting apparatus exclusion operation (Step S30 of FIG. 10). In Step S30, in the printing performance list of FIG. 5, an exclusion flag for an apparatus corresponding to an apparatus ID specified by an argument is set to ON. That is, an exclusion flag of the entry of the selected apparatus 1 in the printing performance list shown in FIG. 5 is set to ON (Step S27 of FIG. 12).

In the printing performance list of FIG. 5, the term “PPM” refers to the print speed. The image qualities are represented by values. The greater the value, the higher the image quality.

The suitable document type of each image forming apparatus can be determined based on these values. Exclusion flags of the image forming apparatuses that are excluded from candidates for selection are set to ON.

(9) The user request destination apparatus selects again the most suitable apparatus for performing printing according to the procedures of FIGS. 7 thorough 9. Thus, it is determined that an apparatus (i.e., an image forming apparatus 6 of FIG. 4, hereinafter referred to as a “selected apparatus 2”) that is more suitable for performing the print job requested by the user than the user request destination apparatus is present on the network 7.

(10) The user request destination apparatus sends a print request transfer (i.e., a “communication 4”) to the selected apparatus 2.

(11) Having received the communication 4, the selected apparatus 2 calculates workload of a print job that the selected apparatus 2 holds according to the flow shown in FIG. 12.

(12) Then, it is determined that the workload is not higher than the predetermined threshold and the selected apparatus 2 can accept the requested job (YES in Step S25). Accordingly, the selected apparatus 2 returns a print request transfer response (i.e., a “communication 5”) to the user request destination apparatus.

(13) The user request destination apparatus sends a print request response (i.e., a “communication 8”) to the PC 3 in order to report an apparatus (the selected apparatus 2 in this example) which is to actually perform printing.

(14) Then, the user request destination apparatus displays information (e.g., apparatus name and IP address) that uniquely identifies the selected apparatus 2 on the operations panel of the user request destination apparatus. This information is contained in a packet of the communication 5 of (12).

(15) The PC 3 sends data to be printed to the selected apparatus 2. Thus the selected apparatus 2 performs printing. Prior to performing printing, in order to send the print data piece to the selected apparatus 2, the printer device driver installed in the PC 3 of the user that has received the communication 8 changes the communication destination from the user request destination apparatus to the selected apparatus 2 based on the information contained in the communication 8.

(16) If the workload on the selected apparatus 1 becomes equal to or less than the predetermined threshold, the selected apparatus 1 sends a print request rejection withdrawal (i.e., a “communication 7”) shown in FIG. 14G to the user request destination apparatus in order to report to the user request destination apparatus that the selected apparatus 1 can accept a print job.

(17) Then, the user request destination apparatus performs a rejecting apparatus exclusion cancellation operation (Step S40 of FIG. 11). In Step S40, in the printing performance list of FIG. 5, an exclusion flag for an apparatus corresponding to an apparatus ID specified by an argument is set to OFF. That is, the exclusion flag of the entry of the selected apparatus 1 in the printing performance list shown in FIG. 5 is set to OFF. Note that a pair of (16) and (17) may occur any time after (7).

According to this embodiment, in the case where a heavy workload is placed on the first selected image forming apparatus (the selected apparatus 1), another image forming apparatus (the selected apparatus 2) is immediately selected, so that it is possible to start printing.

According to the above-described embodiments, it is possible to automatically select an image forming apparatus that can most suitably satisfy a print request from a user. Further, it is possible to forward the print request to the selected image forming apparatus and print the print data without making the user aware of the print request being forwarded.

If an image forming apparatus is newly connected to a network 7, other image forming apparatuses already connected to the network 7 can immediately determined that the image forming apparatus is newly connected to the network 7. That is, each image forming apparatus can always determine all the image forming apparatuses connected to the network 7. Therefore, it is possible to efficiently use each image forming apparatus.

Each image forming apparatus can always determine printing performance capabilities of all the image forming apparatuses connected to the network 7. Therefore, it is possible to satisfy various print requests as an image forming system.

Since each image forming apparatus can store information about all the image forming apparatuses, there is no need to perform communications in order to detect the image forming apparatuses every time printing is performed. As a result, it is possible to reduce the network traffic.

Further, it is possible to calculate a reference value to determine whether printing can be performed when a print request is received.

Further, each image forming apparatus can determine whether the image forming apparatus can satisfy a forwarded print request based on workload on the image forming apparatus.

Further, each image forming apparatus can send information indicating that the image forming apparatus cannot perform printing to an image forming apparatus which has forwarded a print request.

Further, it is possible to select the most suitable image forming apparatus for a print request from image forming apparatuses excluding an image forming apparatus that cannot perform printing.

Further, each image forming apparatus can send information indicating that the image forming apparatus can perform printing to an image forming apparatus which has forwarded a print request. Each image forming apparatus sends its identification information together with the information indicating that the image forming apparatus can perform printing, so that the image forming apparatus which has forwarded a print request can determine the image forming apparatus which can perform printing.

Further, a user can know which image forming apparatus performs printing.

Further, since it is possible to determine that an image forming apparatus which has not been able to perform printing has become able to perform printing, it is possible to include the image forming apparatus that has become able to perform printing as a candidate for selection again in the subsequent procedure.

The present application is based on Japanese Priority Application No. 2007-296062 filed on Nov. 14, 2007, with the Japanese Patent Office, the entire contents of which are hereby incorporated herein by reference.

What is claimed is:

1. An image forming apparatus for use in an image forming system in which a print request apparatus to be used by a user and plural image forming apparatuses are connected via a network, the image forming apparatus comprising:
a print unit configured to print a print data piece;
a communications unit configured to communicate with the print request apparatus and the other image forming apparatuses;
a storage unit configured to store printing performance information pieces of the image forming apparatus and the other image forming apparatuses; and
a selection reporting unit configured to select, when a print request is received from the print request apparatus, one of the image forming apparatuses which has a most suitable printing performance capability for the print request based on the printing performance information stored in the storage unit and report the selected image forming apparatus to the print request apparatus.

2. The image forming apparatus as claimed in claim 1, wherein if the image forming apparatus is selected as the image forming apparatus which has a printing performance capability suitable for the print request, the image forming apparatus receives the print data piece from the print request apparatus based on the print request and causes the print unit to perform printing.

3. The image forming apparatus as claimed in claim 1, wherein when the image forming apparatus is connected to the network, the communications unit sends, to the other image forming apparatuses that are already connected to the network, a connection report indicating that the image forming apparatus is connected to the network.

4. The image forming apparatus as claimed in claim 3, wherein when a connection report indicating that another image forming apparatus is connected to the network is received from the other image forming apparatus, the image forming apparatus sends the printing performance information piece of the image forming apparatus to the other image forming apparatus that has sent the connection report.

5. The image forming apparatus as claimed in claim 4, wherein the storage unit stores the printing performance information pieces received from the other image forming apparatuses that are already connected to the network.

6. The image forming apparatus as claimed in claim 1, further comprising:
a calculation unit configured to calculate, when the print request is received from the print request apparatus, a workload to perform printing based on a printing performance requirement information piece contained in the print request.

7. The image forming apparatus as claimed in claim 6, further comprising:
a determination unit configured to determine whether the image forming apparatus can satisfy the print request based on the calculated workload.

8. The image forming apparatus as claimed in claim 7, wherein when the determination unit determines that the image forming apparatus cannot satisfy the print request, the communication unit sends a rejection report indicating that the printing cannot be performed to one of the other image forming apparatuses.

9. The image forming apparatus as claimed in claim 8, wherein when a rejection report indicating that printing cannot be performed is received from one of the other image forming apparatuses, the selection reporting unit selects another of the image forming apparatuses, excluding the image forming apparatus that has sent the rejection report, which has a most suitable printing performance capability for the print request.

10. The image forming apparatus as claimed in claim 7, wherein when the determination unit determines that the image forming apparatus can satisfy the print request, the communication unit sends a report indicating that the printing can be performed to the one of the other image forming apparatuses together with an identification information piece that uniquely identifies the image forming apparatus.

11. The image forming apparatus as claimed in claim 10, further comprising:
a display unit configured to display an identification information piece is received from one of the other image forming apparatuses together with information indicating that printing can be performed and that uniquely identifies the one of the image forming apparatuses.

12. The image forming apparatus as claimed in claim 8, if the image forming apparatus becomes able to perform printing after the communication unit has sent a rejection report indicating that printing cannot be performed to one of the other image forming apparatuses, the image forming apparatus sends information indicating that printing can be performed.

13. An image forming system, comprising:
a print request apparatus configured to be used by a user; and
plural image forming apparatuses connected to the print request apparatus via a network;
wherein each of the image forming apparatuses stores printing performance information pieces of the image forming apparatuses connected to the network;
the print request apparatus sends a print request to one of the image forming apparatuses; and
the one of the image forming apparatuses selects one of the image forming apparatuses having a printing performance capability suitable for the print request and reports the selected image forming apparatus to the print request apparatus.
